(19) United States
(12) Patent Application Publication
(10) Pub. No.: US 2022/0039313 A1
(43) Pub. Date: Feb. 10, 2022

(54) AUTONOMOUS LAWN MOWER

(71) Applicant: Scythe Robotics, Inc., Longmont, CO (US)

(72) Inventors: John Gordon Morrison, Longmont, CO (US); Isaac Heath Roberts, Longmont, CO (US); Kevin Peter McGlade, Denver, CO (US); Davis Thorp Foster, Boulder, CO (US); Robert Johnstone McCutcheon, IV, Longmont, CO (US); Zachary Austin Goins, Boulder, CO (US)

(21) Appl. No.: 16/985,495

(22) Filed: Aug. 5, 2020

(51) Int. Cl. A01D 34/00; A01D 75/18; G05D 1/02

(52) U.S. Cl. CPC A01D 34/008; A01D 75/185; A01D 2101/00; G05D 1/0223; G05D 1/0268; G05D 1/0219

(57) ABSTRACT

An autonomous lawn mower is described which is provided with boundary information of a region, explores the region, and based on information collected while exploring, is configured to mow the region in accordance with a mow pattern. Exploration may be performed based on random motions, striping, etc. Sensor data captured during exploration is captured in order to determine the presence of any objects within the region (e.g., trees, manmade objects, lakes, and the like). Sensor data and boundary information is used to optimize a mow pattern for the lawn mower to follow when mowing the region. Additional sensor data captured while mowing may be used for obstacle avoidance, monitoring of the system, or otherwise generating notifications.

### BACKGROUND

A typical commercial lawn mower comprises a chassis, motor(s), blade deck and blades, steering mechanism and, for some, a location for an operator to sit or stand while steering the lawn mower. The mower is operated by an operator that rides the mower to control the mower and mow a lawn. For large commercial mowing operations, many operators are used to mow lawns. As such, lawn mowing is labor intensive, which represents a large cost to landscaping companies.

### BRIEF DESCRIPTION OF THE DRAWINGS

The invention will now be described, by way of example, with reference to the accompanying drawings, where like numerals denote like elements, a leftmost numeral indicates the original figure in which the element is found, and in which:

FIGS. 1A and 1B are respectively front and rear perspective schematic views of an autonomous lawn mower in accordance with at least one example of the invention;

FIG. 2 depicts a block diagram of a control system for the autonomous lawn mower of FIGS. 1A and 1B in accordance with at least one example of the invention;

FIG. 3 depicts a block diagram of a controller of FIG. 2 in accordance with at least one example of the invention;

FIG. 4 depicts a flow diagram of a method of operation of the mower of FIGS. 1A and 1B when executing control software using the controller of FIG. 3 in accordance with at least one example of the invention;

FIG. 5 depicts a flow diagram of an initialization method in accordance with at least one example of the invention;

FIG. 6 depicts an aerial, schematic view of a property upon which a boundary is to be defined using the initialization method of FIG. 5 in accordance with an example of the invention;

FIG. 7 depicts a flow diagram of an explore method in accordance with an example of the invention;

FIG. 8 depicts an aerial, schematic view of a property upon which obstacles within the boundary of FIG. 6 are identified using the explore method of FIG. 7 in accordance with an example of the invention;

FIG. 9 depicts another example of an aerial, schematic view of a property upon which obstacles within the boundary of FIG. 6 are identified using the explore method of FIG. 7 in accordance with an example of the invention;

FIG. 10 depicts a flow diagram of a mowing method in accordance with an example of the invention;

FIG. 11 depicts a flow diagram of an explore and mow method in accordance with an example of the invention;

FIG. 12 depicts a flow diagram of a pattern generator method in accordance with an example of the invention;

FIG. 13 depicts a flow diagram of a mower drive method in accordance with an example of the invention;

FIG. 14 depicts an aerial, schematic view of a property to be mowed using the mower drive method of FIG. 13 in accordance with an example of the invention;

FIG. 15 depicts a flow diagram of an obstacle handling method in accordance with an example of the invention; and

FIG. 16 depicts a flow diagram of a mower diagnostic monitoring method in accordance with an example of the invention.

### DETAILED DESCRIPTION

The following detailed description describes techniques (e.g., methods, processes, and systems) that may be used by a lawn mower capable of autonomously mowing grass. In those examples described in detail herein in which one or more autonomous mowers may be used for mowing. If a plurality of autonomous lawn mowers are used in the mowing process, their activity is choreographed such that the mowers work together to complete a mowing task.

A commercial landscaping business may use examples of the present invention to improve their business through substantial labor reduction as well as improved mowing accuracy and speed.

Generally speaking, a mower fleet comprises a plurality of individual mowers, which may be combinations of autonomous, semi-autonomous, and/or manually controlled mowers. Depending on the size of the job, one or more mowers are allocated to a given site. On a given job site, the mowing may be performed using a mix of some autonomous mowers, some semi-autonomous mowers (e.g., those mowers which may have some capabilities which are autonomous and/or which are capable of operating autonomously for at least a portion of the time) and some mowers being driven by humans (i.e., manual mowers). Each autonomous or semi-autonomous mower has a suite of sensors to primarily facilitate autonomous or semi-autonomous mowing. Such sensors may comprise, for example, one or more of cameras, radar, pose (position and/or orientation) systems, diagnostic sensors, Inertial Measurement Units (IMUs) (which in turn may comprise accelerometers, gyroscopes, magnetometers, etc.), torque sensors, wheel rotation sensors (e.g., rotary encoders, Hall sensors, etc.) or the like. This suite of sensors provides a view of the environment in which the autonomous mower is operating such that the mower can explore the environment to identify obstacles and generate mow patterns.

The techniques may provide a technical solution to a technical problem of determining a situational environment in which an autonomous mower is operating or has operated to optimize the behavior of the mower and/or a related mower fleet. The techniques described herein may improve the functioning of a computer through function optimization, improved processing efficiencies, improved and optimized autonomous behavior of mower(s), etc. It would be appreciated that the techniques described herein would be equally applicable to any other service robotics platform and/or fleets thereof such as, but not limited to, other agricultural tasks—harvesting, planting, etc., naval tasks (whether submarine, surface vessel or otherwise), and the like.

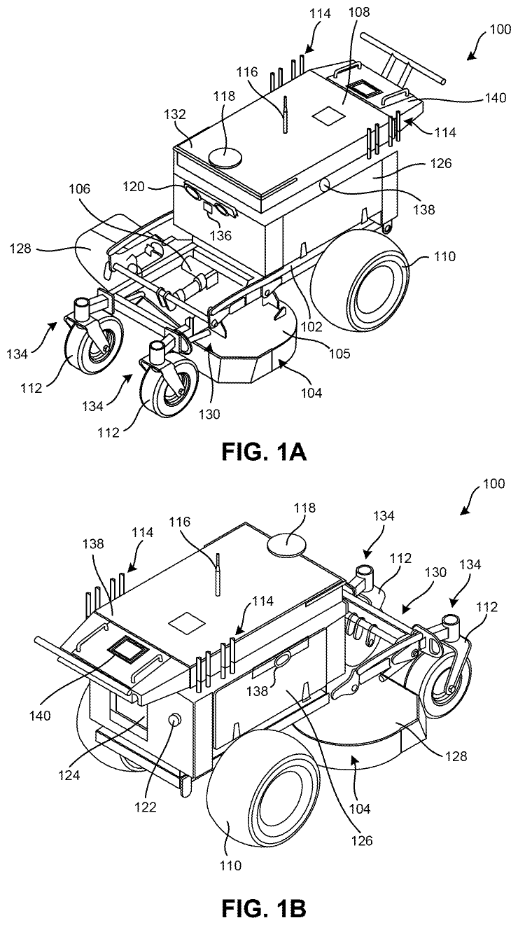

FIGS. 1A and 1B are respectively front and rear perspective schematic views of an autonomous lawn mower 100 in accordance with at least one example of the invention. In an example of the autonomous mower, the mower may be powered by electricity. In other examples (whether autonomous or otherwise), the mower may have another form of energy source, e.g., gasoline, diesel, natural gas, liquid propane, fuel cell, hydrogen, or the like. The mower has one or more drive mechanisms, e.g., motors, facilitating movement of the mower as well as rotating the cutting blades, where the drive mechanism is of a type commensurate with the energy source.

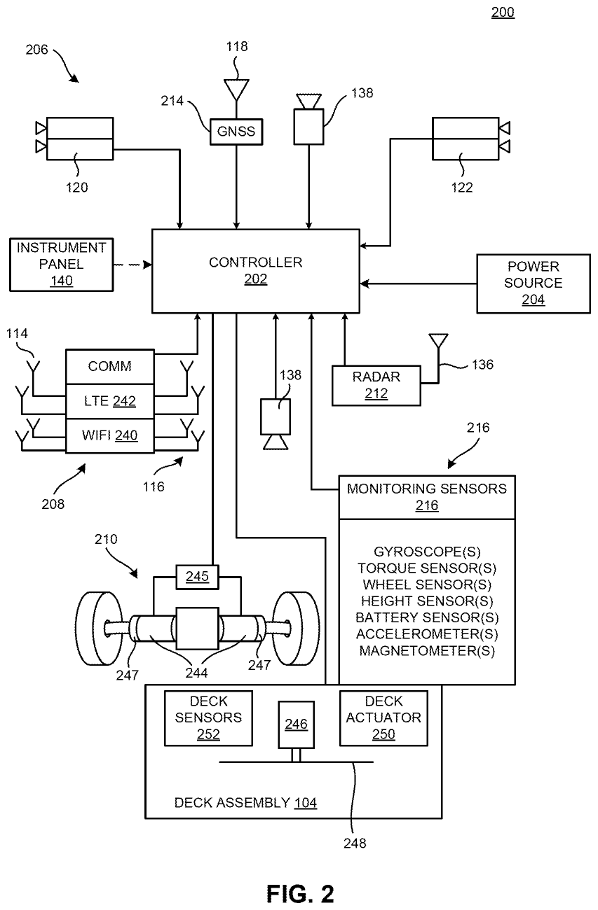

The mower 100 may comprise a chassis 102, front and rear wheels 110 and 112, mower deck assembly 104, and a mower body 132. The mower deck assembly 104 comprises a mower deck 105 and a mower deck control mechanism 106. The chassis 102 may support a mower body 132 which houses batteries, motors and control electronics (not shown in FIGS. 1A and 1B but described in detail with respect to FIG. 2 below). In addition, the chassis 102 may comprise a mower deck assembly support portion 130 extending forward from the body 132. The mower deck 105 may be coupled to the mower deck assembly support portion 130 via the mower deck control mechanism 106. The mower deck control mechanism 106 may comprises actuator(s) to raise and lower the mower deck 104 relative to the support portion 130 and ground as well as an actuator (e.g., motor) to drive one or more blades within the mower deck assembly 104. The mower deck assembly 104 may comprise a cowling 128 for directing grass clippings to one side of the mower 100.

In an example, each rear wheel 110 may be coupled to a drive mechanism, e.g., at least one motor (not shown in FIGS. 1A and 1B). For example, each wheel may be directly driven by a separate electric motor. In other examples, the drive mechanism may include a transmission and/or other form of gearing between the wheels and the motor. The front wheels 112 may be “free-wheeling” in that they are not driven nor are they steered. In such examples, the front wheels 112 comprise, for example, castors. Each wheel 112 may be coupled to the chassis portion 130 via a wheel mounting assembly 134 (e.g., a wheel mounting fork coupled to a spindle to form a castor). In this manner, steering of the mower is effectuated through applying differential rotation of the rear wheels 110. Such differential rotation may be created through rotating each wheel at the same speed and braking one wheel relative to the other or rotating each wheel at a different speed through control of independent wheel drive motors. In other examples, the rear wheels may be driven at equal speeds and a steering assembly may be used to steer the front wheels.

The body 132 may comprise a rear access panel 124 and side access panels 126 to facilitate access to an energy source (e.g., batteries or fuel tank) as well as drive mechanism(s), control electronics, communications electronics, sensor electronics or the like as described further with respect to FIG. 2 below.

The exterior of the body 132 supports various sensors including but not limited to forward viewing camera(s) 120, rear viewing camera(s) 122, side viewing camera(s) 138, radar antenna 136, global navigation satellite system (GNSS) antenna 118, communications antennas 114 and 116 as well as a number of other sensors (described in detail with respect to FIG. 2) that are within the body 132. Additional sensor elements may include one or more of cameras (whether stereo, RGB, monochromatic, infrared, ultraviolet, hyperspectral, etc.), radar(s), lidar(s), accelerometer(s), gyroscope(s), torque sensor(s), magnetometer(s), location system(s), battery management systems, wheel encoder(s), motor sensor(s), orientation sensor(s), and/or the like.

The sensors gather information regarding the environment surrounding the autonomous lawn mower 100 such that the mower 100 is able to autonomously mow a region of lawn within a specified boundary as well as identify obstacles to be avoided, ignored, or cause the mower to cease operation and request human assistance.

The mower 100 may also comprise an instrument panel 140 for enabling manual control of the mower 100. The instrument panel 140 may be removable. A description of an embodiment of the instrument panel and its operation is contained in commonly assigned U.S. patent application Ser. No. 16/891,281, filed 3 Jun. 2020, entitled “Control Interface For Autonomy,” which is hereby incorporated by reference herein in its entirety.

FIG. 2 depicts a block diagram of a control system 200 for the lawn mower 100 of FIGS. 1A and 1B in accordance with at least one example of the invention. The control system 200 may comprise a controller 202 that is coupled to a power source (e.g., a battery) 204, a plurality of sensors 206, a plurality of communications circuits 208 and a plurality of actuators 210 that move the lawn mower as well as the mower deck and mower blade(s).

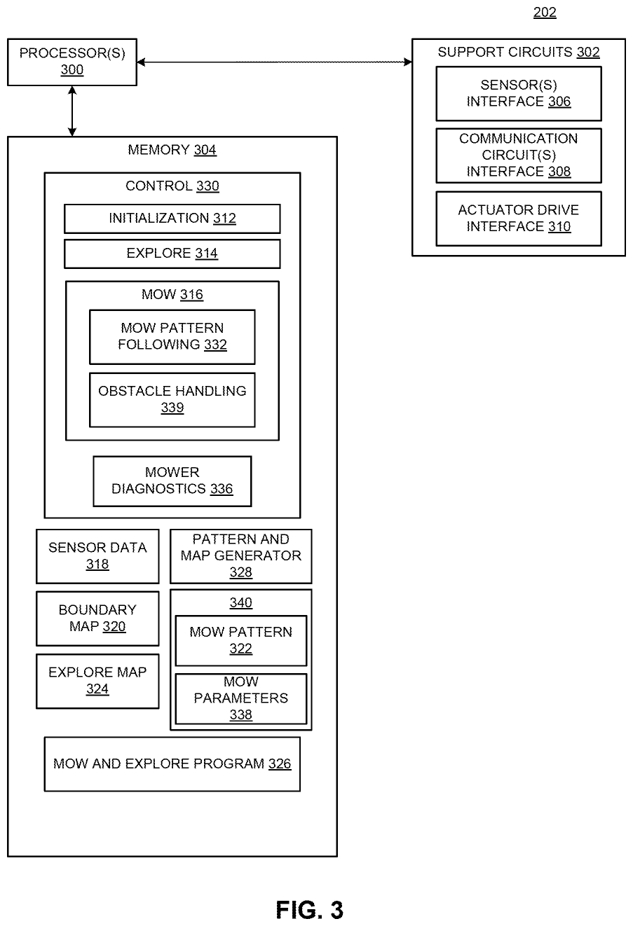

The controller 202, as shall be described in detail with respect to FIG. 3, comprises a computing device, circuits configured to couple to the sensors 206 and receive information therefrom, circuits for coupling information to/from the communication circuits 208, and circuits for driving the actuators 210. With this arrangement, the controller 202 may collect sensor information regarding the environment in which the mower 100 is operating, process the sensor information for use in controlling movement of the mower, and communicate processed and/or raw sensor information to locations remote from the mower 100.

The power source 204 may be a battery, battery pack, fuel cell, or other source of electricity. The energy source 204 may be removable such that the power source can be removed and replaced when the power source does not operate within norms, e.g., recharge capacity is below a capacity threshold. The energy source 204 may include multiple energy sources such as a battery or fuel cell for powering the mower electronics and a tank for gasoline, natural gas, hydrogen, or other fuel for powering one or more motors.

The sensors 206 comprises one or more of, but not limited to, forward viewing camera(s) 120, rear viewing camera(s) 122, side viewing camera(s) 138, radar transceiver(s) 212 (including antenna 136), global navigation satellite system (GNSS) receiver 214 (including antenna 118) and monitoring sensors 216 including, but not limited to, accelerometer(s), gyroscope(s), torque sensor(s), magnetometer(s), location system(s), battery management systems, wheel encoder(s), motor sensor(s), inertial navigation system, and/or the like. The cameras 120, 122, 138 may include any combination of stereo, RGB, monochromatic, infrared, ultraviolet, hyperspectral, etc. Additional sensors may also include lidar(s), orientation sensor(s), inertial measurement unit(s) (IMU(s)) and/or the like. In one example, front and rear cameras 120 and 122 may be stereo camera pairs with an imaging angle of between 55 and 90 degrees. In an example, the side cameras 138 may each be a single camera with wide imaging angle, e.g., up to about 170 degrees. In other examples stereo cameras may be used as side cameras. The controller 202 receives imagery of the environment surrounding the mower from the cameras 120, 122, 138. Additional imagery may be provided to the controller 202 from the one or more radar transceivers 212 (e.g., 77 GHz operating frequency) having one or more radar antennas 136 fixed to the mower body. Mower pose (location and orientation) may be detected, received, or determined based at least in part on the one or more sensor systems described above and/or based at least in part on data received from a GNSS receiver 214. Motion characteristics (e.g., velocity, acceleration direction, and/or the like) may be available from GNSS receiver 214 and the monitoring sensors 216 (e.g., inertial sensors, accelerometers, magnetometers, wheel rotation sensors, and/or the like).

The communications circuits 208 may comprise one or more communications transceivers (modems) 240, 242 and their associated antennas 114 and 116. More specifically, the communication circuits 208 may include, but are not limited to, a pair of WiFi transceivers 240, a pair of LTE transceiver 242, or the like. The antennas 114 and 116 generally may include a plurality of antennas to ensure diverse antenna positioning on the mower body to combat multi-path interference. A pair of transceivers may be used to provide redundancy. For example, two antennas for each transceiver (eight antennas total) are mounted on either side of the body (see FIGS. 1A and 1B). The antennas for LTE/WiFi and GNSS may be collocated in a single antenna housing (dome). One such example of such an antenna is the Combo Outdoor IP67 Roof Antenna available from Teltonika.

Such communications circuits 208 may use protocols that include, but are not limited to, WiFi (802.11), Bluetooth, Zigbee, Universal Serial Bus (USB), Ethernet, TCP/IP, serial communication, and the like. In at least some examples, to minimize an amount of data transferred (as raw sensor data may amount to upwards of multiple gigabytes to multiple terabytes per day), raw sensor data from the one or more sensors 206 may be downsampled, compressed, and/or limited to representations of the data (e.g., bounding boxes in images, etc.) before transmission. In at least one example, sensor data (whether raw, compressed, downsampled, a representation thereof, or otherwise) may be automatically uploaded from the mower control system 200 to another computing device when in a particular location (e.g., when at a landscaper's depot, or other preselected user location). In such examples, the controller 202 may determine, e.g., based at least in part on sensor data from the one or more sensors 206 that the mower 100 is in a depot and begin processing and/or communication of the sensor data. In at least some examples, processing and/or communication may be based on whether the mower 100 is currently connected to a power supply for charging.

The controller 202 may control the drive motor(s) 244 and the mower deck assembly 104. In one example, the drive motors 244 may be one or more brushless DC motors, permanent magnet AC motors, AC induction motors, switched reluctance motors or the like. In one specific example, the motors may be a brushless DC motor, part number 53316, available from HydroGear driven by a motor controller, part number 53283, available from HydroGear. The motor controller circuits (power switching) 245 may be separate from the motors or built into the motors. In one example, the motor controllers 245 may operate on the Field Oriented Control (FOC) principle, a technique that allows a brushless motor to operate at very high efficiency. The motor controllers may use a three-phase half-H inverter design utilizing N-channel MOSFETs (e.g., SiC FETs or IGBTs). The motor controllers 245 may utilize rotor feedback to facilitate accurate FOC motor control via encoders (e.g., inductive, optical, magnetic, or conductive), resolvers, Hall effect sensors, or “sensorless” through back EMF measurements from the motors themselves.

The drive motors 244 may be electronically controlled to perform braking and/or a brake assembly may be coupled to each motor to slow the rotation of each wheel independent, when braking is used to steer the mower, or slow rotation of both wheels simultaneously, when front wheel steering is used to steer the mower. In one example, the control system 200 may use a friction-based braking system 247 with friction pads (either disk, drum, or clutch style brakes) that are coupled to the motor shaft, either before or after a transmission or other gearing that may form part of each motor 244. The braking system 247 may be electromagnetically actuated via a solenoid, linear actuator or other electric-motor driven mechanism. Using such a braking system enables the mower to be held at zero velocity when the mower is not being commanded to move. In addition, a friction based braking system saves power and prevents runaway mowers in the event of emergency stops or system failure. In addition to, or in lieu of, the friction braking system 247, the control system 200 may utilize regenerative braking through control of the drive motors 244. In one example, regenerative braking is used for non-emergency braking during normal operation and friction braking is used during emergency stops and parking. With regenerative braking, energy from mower inertia is either transferred into the battery(ies) and/or into a brake resistor.

The deck assembly 106 may comprise at least one drive motor 246 for the blades 248, at least one deck actuator 250 for raising and lowering the deck (104 in FIG. 2) relative to the grass, and at least one deck sensor 252. The at least one drive motor 246 may be, for example, a brushless DC motor rotating the blades at, for example, about 1000 RPM up to about 5000 RPM when operating nominally. The at least one deck actuator 250 may comprise a linear actuator such as solenoid(s), ball screw(s), rack and pinion assembly(ies), hydraulic/pneumatic piston, or the like. The at least one deck sensor 252 may comprises at least one sensor for determining a height of the blades relative to the grass and/or the chassis (e.g., a Hall effect sensor) as well as at least one sensor for measuring blade rotation parameters such as RPM, velocity, torque sensor or the like. Blade control and its relationship to mower speed is described in detail in commonly assigned U.S. patent application Ser. No. 16/923,174, filed 8 Jul. 202, entitled “Degraded Performance Detection and Control,” which is hereby incorporated by reference herein in its entirety.

FIG. 3 depicts a block diagram of the controller 202 of FIG. 2 in accordance with at least one example of the invention. The controller 202 may comprise at least one processor(s) 300, support circuits 302, and memory 304. The controller 202 may include one or more processors as part of the processor(s) 300, any of which, either individually or in combination, are capable of performing the operations described herein. Some processing to fulfill the functions of the mower may be performed locally, may be performed remotely on a server (or other system/subsystem)(not explicitly shown, but functionally part of controller 202), or may be shared and performed locally and remotely. For example, the processor(s) 300 may comprise, one or more or any combination of, microprocessors, microcontrollers, central processing units (CPUs), graphics processing units (GPUs), digital signal processors (DSPs), field programmable gate arrays (FPGAs), application specific integrated circuits (ASICs), or the like. In one example, the controller 202 may include a model Jetson Xavier computing module available from Nvidia Corporation.

The support circuits 302 may comprise circuits and devices that support the functionality of the processor(s) 300. The support circuits 116 may comprise, one or more or any combination of: clock circuits, communications circuits, cache memory, power supplies, interface circuits for the various sensors, actuators, and communications circuits of FIG. 2, and the like. More specifically, the support circuits 302 may comprise sensor(s) interface 306, communication circuit(s) interface 308, and actuator drive interface 310. The sensor(s) interface 306 may support data transfer from the sensors 206 in FIG. 2 to the processor(s) 300 through one or more, or any combination of, data buffering/caching, signal digitizing, signal amplification, digital and/or analog signal processing, filtering, limiting, and/or the like.

The communication circuit(s) interface 308 may support data transfer to/from the communications circuits 208 in FIG. 2 (e.g., LCE and/or WiFi transceivers) to/from the processor(s) 300 through one or more, or any combination of, digital and/or analog signal processing, filtering, limiting, amplifying, and/or the like.

The actuator drive interface 310 may support control of the actuators 210 of FIG. 2 (e.g., drive motors, brake system, blade motors, deck actuator, etc.) through one or more, or any combination of, current, voltage or pulse width modulated signal controllers in the form of motor controllers, brake controllers, solenoid controllers and/or the like.

Memory 304 is an example of non-transitory computer readable media capable of storing instructions which, when executed by any of the one or more processor(s) 300, cause the controller 202 to perform any one or more of the mower operations described herein. The memory 304 can store an operating system and one or more software applications, instructions, programs, and/or data to implement the methods described herein and the functions attributed to the various systems. In various implementations, the memory 304 can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein. Additionally, or alternatively, the memory 304 is capable of storing raw sensor data 318 from the one or more sensor(s) 206, compressed or downsampled sensor data, output of one or more machine learning models (e.g., feature maps of neural networks), and/or representations of the raw sensor data.

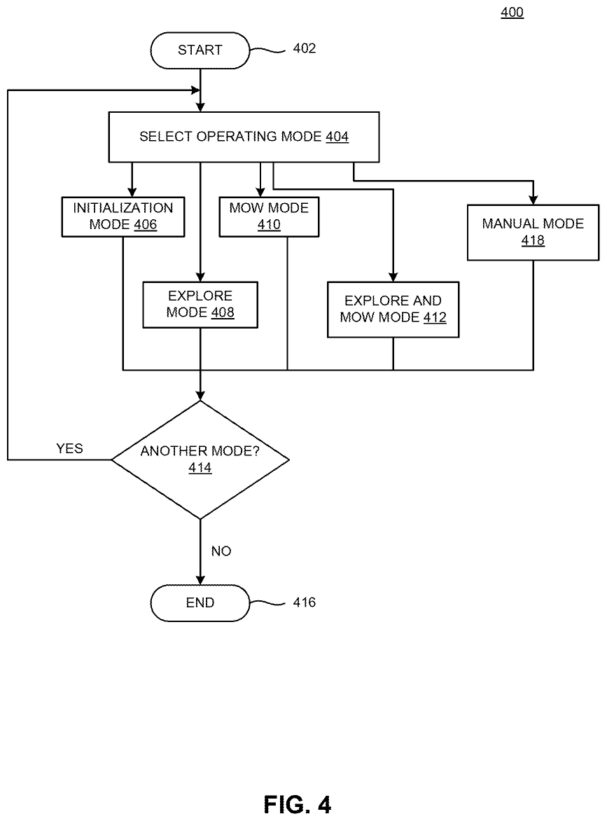

The memory 304 may store various programs and data such as, for example, but not limited to, a control program 330 having one or more subprograms such as an initialization program 312, an explore control program 314, a mow control program 316, and mower diagnostics program 336. The mow control program 316 may comprises additional programs (e.g., subprograms, subroutines and/or interrupt routines) such as, for example, mow pattern following program 332 and/or obstacle handling program 334. The function of each program is described below with respect to FIGS. 4 through 16.

The data 318 (or representations/derivations therefrom) may be, in some examples, communicated to a local site manager device, customer device and/or server, as needed or requested, where additional processing and analysis may occur. Such communication and utilization of the data at remote locations is described in detail in commonly assigned U.S. patent application Ser. No. 16/894,379, filed Jun. 5, 2020, entitled “Autonomous Lawn Mowing System” which is hereby incorporated herein in its entirety.

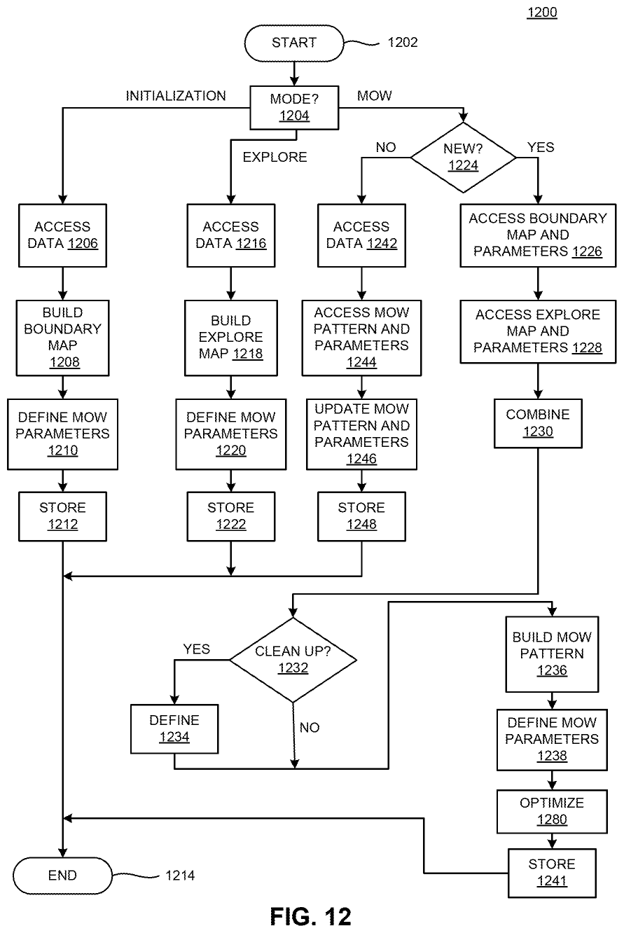

The memory 304 further may store various control patterns used to control the operation of the mower including one or more, or any combination of: a boundary map 320, a mow pattern 322, an explore pattern 324, and an explore and mow pattern 326. Each pattern 320, 322, 324 326 may be generated or updated by executing the pattern generator program 328 locally on the processor(s) 300 and/or generated remotely by executing a pattern generator program on a server, then uploading one or more patterns 320, 322, 324 326 to the memory 304 for use by the mower. The operation of the pattern generator program 328 is described below with respect to FIG. 12. The mow pattern 322 may be associated with mow parameters 338 (e.g., mower speed, blade height, blade speed, deck type of side discharge, rear discharge, or mulching etc.) that are used while performing the mow pattern 322. The combination of a mow pattern and mow parameters forms a mow task 340.

FIG. 4 depicts a flow diagram of a method 400 for operation of a mower when executing the control software (e.g., 330 in FIG. 3) in accordance with an example of the present invention. Any block, step, module, or otherwise described below may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

The method 400 begins at 402 and proceeds to 409 where an operator may select an operating mode for the mower. For example, operating modes may include one or more of an initialization mode 406, an explore mode 408, a mow mode 410, an explore and mow mode 412 and/or a manual mode 418. The initialization mode 406 facilitates defining a boundary in which mowing will occur, the explore mode 408 facilitates the mower's exploration with in the interior of the boundary to collect information regarding the region to be mowed and generate a mow pattern based on the boundary and explore modes, the mow mode 410 uses the mow pattern to mow the region of the property defined by the boundary, and the explore and mow mode enables the mower to explore the region within the boundary and build a mow pattern while simultaneously mowing the region.

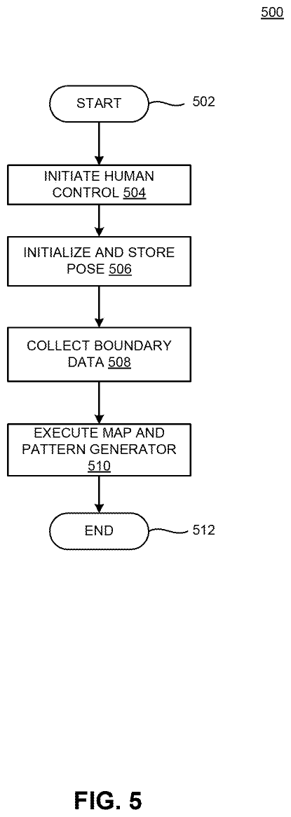

The initialization mode 406 may be selected when a mower is located at a property for the first time and a mow pattern is not available to use to control the mower. In short, the initialization mode 406 enables an operator to manually control the mower to define a boundary for the autonomous mowing. The boundary may be the perimeter of a property or perimeter of a region of a property in which the mower will autonomously operate. Alternatively, the perimeter may be defined through a user drawing (or otherwise defining) a perimeter of the region to be mowed on a computer screen. Details of the initialization mode are described below with respect to FIG. 5.

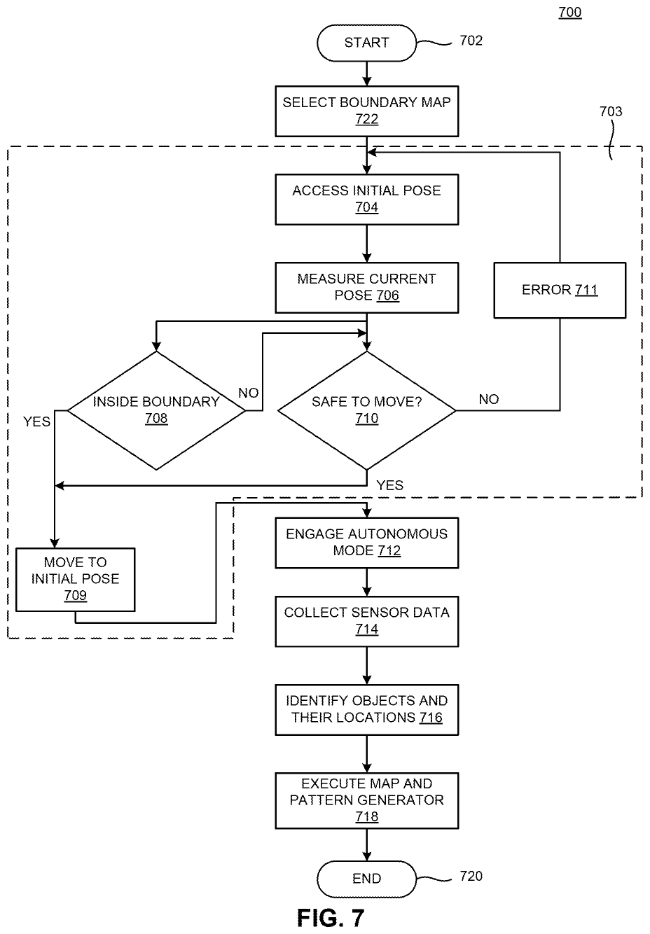

The explore mode 408 may be selected when a boundary has previously been defined and the mower is allowed to autonomously explore the interior of the boundary to determine the location of obstacles (e.g., trees, bushes, buildings, fences, ponds, creeks and/or the like) as well as collect information regarding the mowing environment (e.g., grass thickness, grass height, hills, and/or the like). After exploration, this information may be used to determine a mow pattern and mow parameters (e.g., blade height, mower speed, blade speed, deck type of side discharge, rear discharge, or mulching and/or the like) to be used to mow the property. The explore mode 408 is described in detail below with respect to FIG. 7.

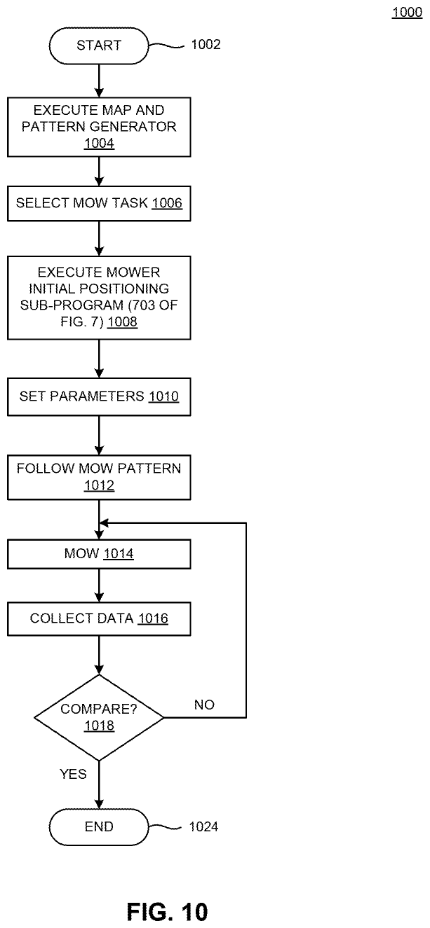

The mow mode 410 may be selected when a mow pattern for the property is known and the operator desires the mower to mow the property. During mowing, the mower may collect additional data regarding the property and use this additional data to update the mow pattern to, for example, add new obstacles, remove obstacles that are no longer present, update mower parameters, and/or the like. The mow mode 410 is described in detail below with respect to FIG. 10.

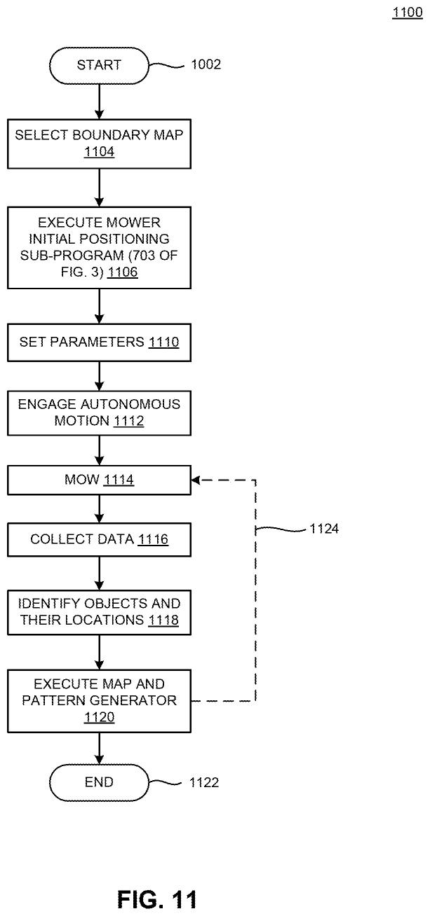

The explore and mow mode 412 may be selected when the mower is being operated at a property for the first time and the operator desires the mower to mow while it is exploring the property. In this mode, while exploring a property in a manner of the explore mode 408, the mower uses preliminary mow parameters to mow the property while exploring. The data collected from the sensors while exploring and mowing is used to generate a mow pattern and mow parameters for the next time the mower mows the property. The explore and mow mode 412 is described in detail below with respect to FIG. 11.

The manual mode 418 may be selected when the mower requires human control either to reposition the mower, obstacle avoidance, mow or re-mow an area and/or the like. In one example, the mower is locally controlled through manipulation of the instrument panel (140 in FIGS. 1A and 1B) or remotely controlled via a control application executing on a mobile device or computer. Such manual control of the mower is described in detail in commonly assigned U.S. patent application Ser. No. 16/894,379, filed 5 Jun. 2020, entitled “Autonomous Lawn Mowing System” which is hereby incorporated herein in its entirety.

Once the operation associated with a selected mode is completed, the method 400 proceeds to the query at 414 where the method 400 queries whether another mode is to be selected. For example, after completion of the initialization mode 406 to define a mowing boundary, an operator may desire the mower to develop a mowing pattern and select the explore mode. As such, if the query at 414 is affirmatively answered, the method 400 returns to 404. If the query is negatively answered, the method 400 ends at 416.

FIG. 5 depicts a flow diagram of an initialization method 500 that is invoked when the initialization mode (406 of FIG. 4) is selected in accordance with an example of the invention. The initialization method 500 represents operation of the mower when the controller 202 executed the initialization program 312 in FIG. 3. The method 500 may be executed when the mower is being used on a property for the first time. While the mower is in initialization mode, an operator positions the mower in a starting pose (location and orientation), then manually drives the mower to define a boundary within which the mower will subsequently autonomously mow. The boundary may be a perimeter of a property to be mowed or the perimeter of a region to be mowed by the particular mower on the property, i.e., other mowers in a fleet of mowers may mow other regions to completely mow a property.

The method 500 begins at 502 and proceeds to 504 where an operator places the mower under human control. While under human control, an operator may attach a removable controller console to the mower and a trailer for the operator to stand on while manipulating the controls to drive the mower under manual control. Such a control system is described in detail in commonly assigned U.S. patent application Ser. No. 16/891,281, filed Jun. 3, 2020, entitled “Control Interface for Autonomy” which is hereby incorporated herein in its entirety. In other examples, the human controls may be built into the mower or the mower may be controlled remotely via a smart phone, digital assistant, remote control pad, and/or the like. No matter the physical controller type or whether it is attached or remote, the operator is capable of manually controlling the mower (e.g., steering and speed) to define the boundary.

In another example, boundary data may be collected without using the mower (i.e., using a mower proxy). For example, a person could traverse the boundary (e.g., walk, bicycle, or the like) while a mobile device executing a boundary application collects location information as the boundary is traversed. The location information may be provided by a GNSS, inertial navigation system, etc. In another alternative, a person may enter the boundary data manually into a boundary generation program via entering boundary location points (e.g., latitude and longitude points), drawing a boundary that is then converted into a boundary locations, or use any technique to create a boundary for the mower's operation. In a further alternative example, a boundary map may be derived from aerial imagery from a drone or satellite either by computer vision and/or machine learning techniques (e.g., semantic segmentation) and/or provided by a user (e.g., by providing waypoints indicative of the boundary via a graphical user interface).

At 506, assuming the mower is used to define the boundary, the method 500 may initialize a pose of the mower prior to the operator moving the mower and store the initial pose as sensor data. The operator may then drive the mower along the boundary while, at 508, boundary data is collected (i.e., gather and store). The boundary data represents the environment in which the mower is being driven as generated by the various sensors, including the pose of the mower as the mower moves along the boundary. The boundary data may define a contiguous path along which the driver has driven the mower from the initial position back to the initial position. The mower may be mowing or not mowing during the boundary data collection process. If mowing, the boundary data will include additional information such as blade deck height and blade speed. These parameters may be automatically generated through analysis of sensor data or manually entered by the operator.

At 510, the method 500 executes a map and pattern generator (328 in FIG. 3) to analyze the boundary data and produce a boundary map. The pattern generator method is described in detail below with respect to FIG. 12. The boundary map may be generated as the boundary data is collected or the boundary map may be generated after all the boundary data is collected or entered (either locally at the mower and/or remote by a remote device after transmitting data measured and/or determined during the initialization procedure described in method 500). In either case, the boundary map may comprise a sequence of waypoints indicative of one or more of a mower state (position, orientation, velocity, blade height, blade speed, etc.). The pattern may include or have associated therewith mower parameters such as one or more of mower speed, brake application parameters (e.g., location, amount and duration of brake application), blade speed, blade deck height, and/or the like. The initialization method 500 ends at 512.

If multiple mowers of a mower fleet are mowing the property, each mower performs the forgoing method 500 to produce a boundary of a given region. In another example, the fleet may mow the same region, where one mower is used to define the boundary and the boundary is shared with other mowers (such as divided into differing sections, interlacing striping of a unified area, etc.).

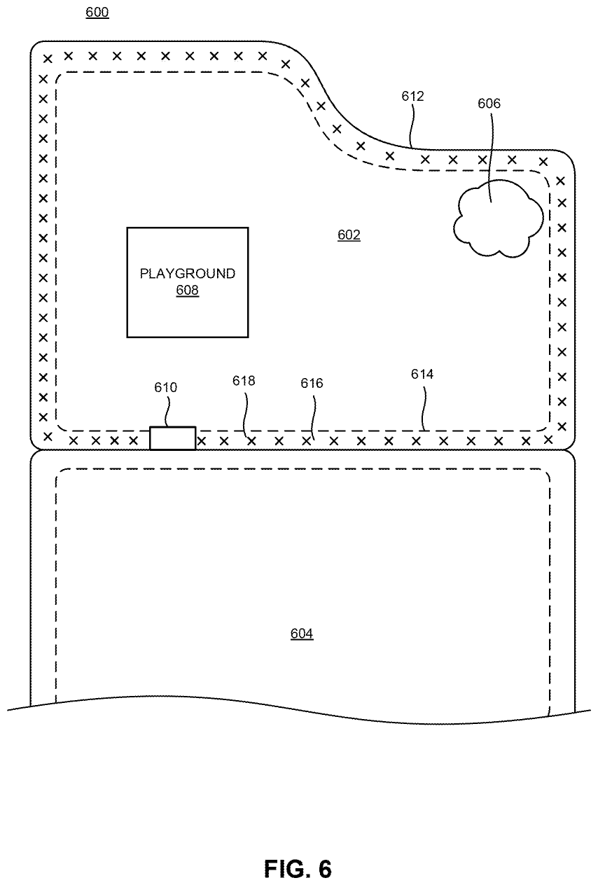

FIG. 6 depicts an aerial, schematic view of a property 600 upon which a boundary is to be defined in accordance with an example of the invention. In one example, method 500 of FIG. 5 is used to define the boundary, a boundary map being determined therefrom. The property 600 comprises a region 602 to be mowed. Properties may comprise multiple regions, for example, regions 602 and 604, that may be simultaneously mowed by different mowers. The property 600 may contain various obstacles such as a tree 606 and a playground area 608. Obstacles are, in general, defined as any portion of the property that cannot be mowed such as fences, buildings, bushes, trees, fixed play equipment, pools, bodies of water, etc.

As described above with respect to FIG. 5, the mower (for example, mower 100 of FIGS. 1A and 1B) is positioned at an initialization pose 610 and driven around the perimeter 612 of the region 602 to define the boundary 614. The boundary map may define a mower boundary path 616 as a series of waypoints 618 (each waypoint comprising a mower state. The periodicity of the data points may be uniform or may have a varied density along the path 616, e.g., more points at a turn and less points when traveling in a straight path. While following the boundary, the mower may be mowing or not mowing.

FIG. 7 depicts a flow diagram of an explore method 700 that is invoked when the explore mode (408 in FIG. 4) is selected in accordance with an example of the invention. In the explore mode, the mower controller executes the explore program 314 of FIG. 3 and the mower operates autonomously to explore an area within a previously defined boundary. The result of the exploring process is an explore map representing the environment of the explored area, e.g., locations of obstacles (i.e., areas that cannot be mowed) within the region defined by the boundary.

The method 700 begins at 702 and proceeds to 722 where a boundary map is selected for the region to be explored. At 703, a mower initial positioning sub-program is executed to properly position the mower for the task ahead, in this instance, exploring the region. Upon executing the mower initial positioning sub-program, the method 700 proceeds to 704 where the mower may access the initial pose stored during the initialization method 500 of FIG. 5. At 706, the sensors (e.g., GNSS, gyroscope, accelerometer, cameras, etc.) may be used to measure the current pose. At 708, the method 700 queries whether the current pose indicates a location that is inside the boundary. If the mower is inside the boundary, at 709, the mower autonomously moves to the initial pose. If the mower is outside the boundary, at 710, the method 700 queries whether the mower is safe to move, that is, does the mower have a known path to traverse to the initial pose location such as a sidewalk or a short driving distance. If so, the method 700, at 709, moves the mower to the initial pose location. However, if the mower does not have a path to the initial pose location, the query at 7010 indicates a lack of a path and the method 700 may display an error message to the operator. Such display may be a message (e.g., text, email, etc.) to the operator's smart phone, an error indicator illuminated on the mower and/or the like. Any form of indicator may be used to notify the operator that the mower is not in a position to move to the initial pose location. Once the mower is in the initial pose location, the method 700 ends the initial positioning sub-program and may proceed to 712.

At 712, the method 700 may engage autonomous motion of the mower. Any technique may be used for exploring the area within the boundary (i.e., a so-called geo-fence). For example, the mower may move on a random walk through the area, i.e., move in a straight path to the boundary or an obstacle, make a randomly angled turn, proceed again in a straight path to the boundary or an obstacle, and repeat until a predefined percentage of the area has been traversed by the mower. In another example, the mower may traverse the area by striping the region, i.e., travel in a straight path, make a 180 degree (U-turn), and travel in a straight path that is offset by one mower with from the first path. A turn is made when the mower encounters the boundary or an obstacle. Each path forms a so-called stripe. While in explore mode, the mower may perform such stripes having larger widths (distances between stripes) than when mowing. In such examples, the width (or distance between stripes) during exploration may be based on a maximum object size that is identified in the region, i.e., the mower will travel around a tree (small object), but will turn around at the edge of a lake or building (large object). In similar examples, the width between stripes may be determined based at least in part on a combined field of view (or single field of view) of one or more of the sensors available to the lawn mower. In such examples, the width may be determined such that all obstacles within a given region may be determined without the need to traverse the entirety of the region. As such, the explore pattern may vary depending upon the objects and their sizes that are identified in the region being explored.

At 714, as the mower explores, the method 700 collects sensor data regarding the environment surrounding the mower. The collected data is used at 716 to identify objects and their locations within the area. In one example, objects may be identified simply as perimeter shapes of obstacles covering certain portions of the area that are defined as interior boundaries that are not to be mowed. In other examples, the objects may be specifically identified through object recognition algorithms to identify trees, bushes, buildings, etc. Such identification may be performed using machine learning algorithms. One non-limiting example of machine learning algorithms is an Artificial Neural Network (ANN). ANNs are biologically inspired algorithms which pass input data through a series of connected layers to produce an expected output. Each layer in a neural network may also comprise another neural network, or may comprise any number of layers (whether convolutional or not). As may be understood in the context of this disclosure, a neural network may utilize machine learning, which may refer to a broad class of such algorithms in which an output is generated based on learned parameters. Here, various neural networks may be trained to output object identification and location based on at least a portion of the sensor data. Such output may then be associated with the two- or three-dimensional map. For example, input having a known output may be provided to the ANN to adjust various internal parameters, such that when known input is given, an estimated output is provided.

To assist with object location and identification, aerial imagery from a satellite or drone may be used to seed the processing above with approximate object locations and/or initial identification of the objects.

At 718, the method 700 executes the map and pattern generator (328 in FIG. 3) to utilize the collected sensor data to generate an explore map, i.e., a map of the area within the boundary where obstacles are identified. The explore map may represent the obstacles are areas, geometric shapes, blobs, etc. in which the mower may not mow. A detailed description of operation of the pattern generator is described below with respect to FIG. 12. The method 700 ends at 720.

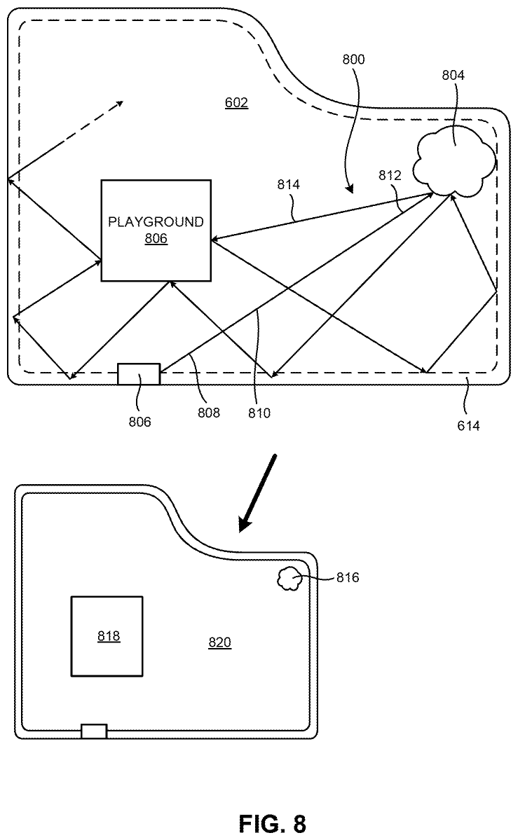

FIG. 8 depicts an aerial, schematic view of the region 602 of FIG. 6 showing an exemplary random walk explore path 800 and an exemplary resulting explore map 802 in accordance with at least one example of the invention. The region 602 comprises objects that may form obstacles to the mower—for example, a tree 804 and a playground area 806. To produce the explore map 802, the mower is positioned at or moves to the initial location 806 with the initial pose. For a random walk explore path, the mower selects a random angle 808 and moves in a straight path 810 until the mower approaches an object, e.g., tree 804, or the previously defined boundary 614. As the mower approaches the object, the mower identifies the obstacle's existence and maps its location as well as size, i.e., creating a do not mow region or portion thereof. Over time, with multiple approaches to the object, a full boundary of the object may be developed, e.g., 816 in the explore map 802.

When the mower reaches the object, the mower may select a random angle 812, turns the mower and progresses in a straight path 814. This process of drive along a straight path until an obstacle or boundary is reached, then turn a random amount and proceed again, produces a random walk pattern 800 until substantially all of the region has been explored. Ceasing the explore process may be caused by an operator seeing that the mower has substantially covered the region or the mower itself may compute the area of the region from the boundary information and stop when the random walk path has covered a substantial portion of the computed area. Alternatively, in view of the size of the region, a specified amount of time may be established and used by the mower for exploring. In such example, one or more of velocities, widths between stripes, and the like may be optimized over with respect to an area to be mowed to ensure that the exploration is completed within the given amount of time while optimizing detections of objects, differing mowing conditions (e.g., differing varieties of grass, etc.), and the like.

The result of the explore process is, for example, an explore map 802 that indicates areas that cannot be mowed—for example, areas 816 and 818, respectively representing the tree 804 and playground 806. The mowable region is the remaining area 820.

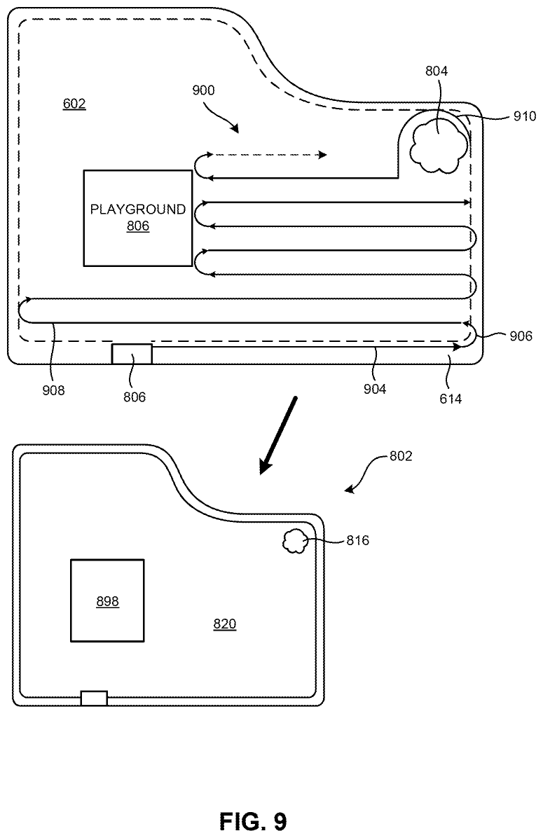

FIG. 9 depicts an aerial, schematic view of the region 602 of FIG. 6 showing an exemplary striping explore pattern 900 and an exemplary resulting explore map 902 in accordance with at least one example of the invention. In this example, rather than a random walk pattern, the mower may proceed from the initial location 806 in a straight path 904 until the mower reaches the boundary 614. At the boundary, the mower may make a 180 turn (U-turn or K-turn) 906 resulting in the mower being offset by a mower width from the prior path 904 and proceeds in a straight path 908. In another example, since the mower is identifying large objects while exploring, the mower may be offset after a turn by more than a mower width. Each time an object (e.g., playground 806 or tree 804) or boundary 614 is encountered by the mower, the mower makes a turn and continues to “stripe” the region. At objects, the mower may follow a path 910 around the object to map its location. For larger objects, such as the playground 806, the mower may move around the perimeter of the obstacle upon first encounter or it may continue a striping pattern where a turn is made on each encounter until the perimeter of the object is mapped. For very large objects (e.g., lake, house, barn, etc.), that cannot be circumscribed, the mower may map a portion of the object and recognize that the remainder form part of the boundary. The differing object behavior may be based on any one or more of sensor segmentation, detections, classifications, a percentage of sensor data represented by the obstacle (which may be associated with a distance to the obstacle), etc.

After striping substantially all of the region 602 within the boundary 614, the explore map 802 containing the obstacles 818 and 820 is generated using the map and pattern generator (328 in FIG. 3).

Although two examples of explore patterns 800 and 900 are described, other examples of algorithms that could be used include, but are not limited to, expanding direction algorithm, Dijkstra's algorithm, A*, D* search algorithm, etc.

FIG. 10 depicts a flow diagram of a mowing method 1000 that may be used by the mower to mow a region in accordance with at least one example of the invention. The mowing method 1000 may be invoked when controller 202 in FIG. 2 executes the mow program 316 of FIG. 3). The mowing method begins at 1002 and proceeds to 1004 where the method 1000 executes the map and pattern generator, as necessary, to update the mow patterns for the region being mowed based on the sensor data collected during a prior mowing process. For example, during a prior mowing of the region, the mower (or another mower in the fleet) may have encountered a new obstacle or may have identified a portion of the lawn where the grass is dense requiring increased blade speed or decreased mower speed. Changes may be made to the mow patterns and/or mow parameters to include the new information regarding the environment. Similarly, the pattern generator may optimize the mowing pattern based on the starting position of the mower to reduce an amount of energy consumption, time to mow, number of turns, to account for obstacles, and the like.

At 1006, a mow task (containing a mow pattern and mow parameters) may be selected by an operator. The mow task may be generated locally within the mower or generated remotely and uploaded from a server. The upload may be performed while the mower is located at a depot before deployment to the field or the upload may be performed wirelessly to the mower after it has been fielded. The selection of the mow task may be automatic and may occur upon uploading the pattern and parameters. A process that may be used to generate the mow pattern is described in detail in FIG. 12.

Prior to beginning a mowing session, the mower may be positioned at the initial pose used by the initialization method 500 for creating the boundary or the mower may drive itself to the initial pose location. At 1008, the mower executes the mower initial positioning sub-program (703 in FIG. 7) to attain the initial pose for the mower or, if the initial pose is not attainable, notify an operator.

At 1012, the method 1000 sets the mow parameters (e.g., mower speed, blade speed, blade deck height, deck type of side discharge, rear discharge, or mulching etc.) to be used during the mowing session. These parameters may be changed during the mowing session either in accordance with the mow task, via operator adjustment, or by the mower as the mower analyses the environment in which it is mowing.

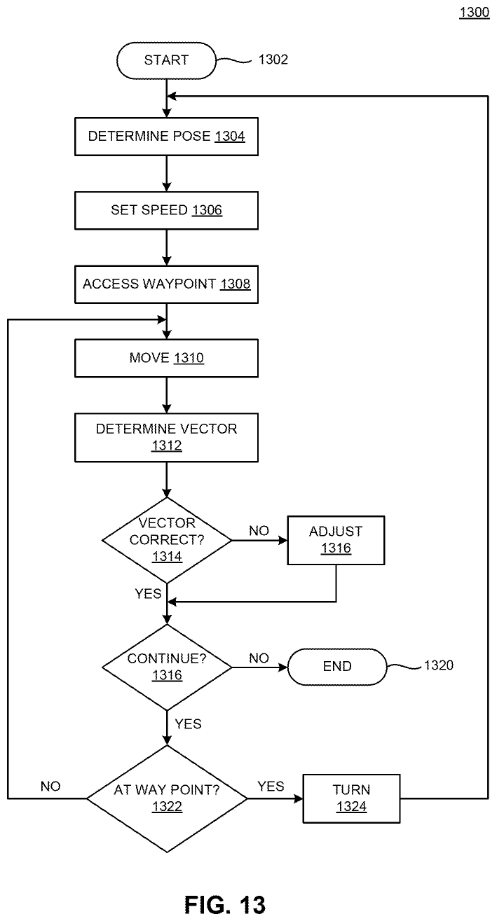

At 1014, the mower begins to operate autonomously and follow the mow pattern. At 1016, mowing commences with the blades rotating at a speed and height in accordance with the mow parameters and the mower moving at a speed in accordance with the mow parameters. Details of the mowing method performed at 1016 are described in detail below with respect to FIG. 13.

As the mowing proceeds, at step 1018, the mower collects sensor data (i.e., images and measures the surrounding environment and stores the data). As shall be described below, the collected sensor data is used to detect obstacles, correct the mower path, update the mow pattern, etc.

At 1020, the method 1000 queries whether the mowing is complete. If the query is negatively answered, the method 1000 returns to 1016 to continue mowing. If the query is affirmative answered, the method 1000 ends at 1024.

FIG. 11 depicts a flow diagram of an explore and mow method 1100 that is invoked when the explore and mow mode is selected in accordance with an example of the invention. In the explore and mow mode, the mower controller 202 executes the explore and mow program 326 of FIG. 3 and the mower operates autonomously to explore an area within the previously defined boundary while simultaneously mowing the region as it explores. The result of the exploring and mowing process is an explore pattern representing the environment of the explored area, e.g., locations of obstacles within the area defined by the boundary, and the region being mowed.

The method 1100 begins at 1102 and proceeds to 1104 where a boundary map is selected to define the region in which the mow and explore process will be performed. At 1106, the mower executes the mower initial positioning sub-program (703 in FIG. 7) to attain the initial pose for the mower or, if the initial pose is not attainable, notify an operator.

At 1110, the method 1100 may set the mow parameters (e.g., mower speed, blade speed, blade height, etc.) and proceeds to 1112 to engage the autonomous motion of the mower. While moving, at 1114, the mower mows the grass while exploring the region. Any technique may be used for exploring the area within the boundary (i.e., a so-called geo-fence). For example, as described with respect to the explore method of FIG. 7, the mower may move on a random walk through the area, by striping the region or by using some other search algorithm. It may be beneficial to use the striping method because the mowing coverage may be more precise.

At 1116, as the mower explores and mows, the method 1100 collects sensor data regarding the environment surrounding the mower. The collected data is used at 1118 to identify objects and their locations within the region. In one example, objects may be identified simply as perimeter shapes of obstacles covering certain portions of the area that are defined as interior boundaries that are not to be mowed. In other examples, the objects may be specifically identified through object recognition algorithms to identify trees, bushes, buildings, etc. As mentioned above, such identification may be performed using artificial intelligence in the form of ANN.

At 1118, the method 1100 executes the map and pattern generator to utilize the collected sensor data to generate an explore map, i.e., a map of the area within the boundary where obstacles are identified. In one example, the explore pattern being used to explore and mow may be improved and optimized as the explore process progresses (i.e., the map and pattern generator is continuously executed as additional environment information is available and the updated pattern is immediately used by the mower). As such, the more information regarding the environment that is gathered, the better the mow coverage becomes. This optional iterative process is indicated by the dashed path 1124. A detailed description of operation of the pattern generator is described below with respect to FIG. 12. The method 1100 ends at 11122.

FIG. 12 depicts a flow diagram of a map and pattern generator method 1200 that may be used to generate the boundary map, the explore map, and/or the mow pattern as well as update and/or optimize a mow pattern in accordance with at least one example of the invention. The method 1200 is invoked when any other method or mode executes the pattern generator (e.g., the pattern generator program 328 illustrated in FIG. 3).

The method 1200 begins at 1202 and proceeds to 1204 where the method 1200 may chooses to generate a boundary map, an explore map, or a mow pattern and their related mow parameters. The selection is based upon which mode (i.e., initialization, explore, or mow) is presently operating and which method (initialization, explore, mow or explore and mow) calls the pattern generator program to execute.

If the initialization method executing during the initialization mode calls the pattern generator program, the method 1200 proceeds to 1206 where the method accesses (or otherwise receives) sensor data related to the boundary. At 1208, the method 1200 builds a boundary map using the stored pose of the mower as it was driven along the perimeter of the region to be mowed as described above with respect to FIG. 5 (or using, for example, a mower proxy such as a person walking the region to be mowed or person otherwise indicating the boundary location as described above with respect to FIG. 5). Using the sensor data and/or data entered by an operator, at 1210, mow parameters (e.g., mower speed, blade speed, blade height, etc.) are defined for mowing the boundary. At 1212, the method 1200 stores the boundary map and mow parameters related to the boundary and ends at 1214.

If the explore method (or the explore and mow method) calls the pattern generator program, the method 1200 proceeds from 1204 to 1216 where the method accesses (or otherwise receives) sensor data related to the explore process. Both the explore method and explore and mow method utilize the explore branch of the pattern generator. At 1218, the method 1200 builds an explore map (e.g., a map of interior of the boundary, including any obstacles, grades of terrain, types of vegetation to be mowed, and the like) using the stored sensor data from the mower as it autonomously drove (or is driving) in the interior of the region to be mowed as described above with respect to FIGS. 7, 8 and 9 (as well as explore and mow method of FIG. 11). Using the sensor data and/or data entered by an operator, at 1220, mow parameters (e.g., mower speed, blade speed, blade height, etc.) are defined for mowing the interior area. At 1222, the method 1200 stores the explore map and mow parameters related to the interior of the boundary and ends at 1214.

If the mow method calls the pattern generator during the mow mode, the method 1200 proceeds from 1204 to 1224 where the method queries whether the mow pattern is to be a new mow pattern. The query can be answered automatically, based on whether a mow pattern for the property currently exists, or an operator may make a selection to create a new pattern even if a prior pattern exists. If the query is affirmative answered, the method 1200 proceeds to 1226 where the method 1200 may access the boundary map and related mow parameters for the region to be mowed. The mow parameters may include the initial pose of the mower such that a mow pattern may consider the starting pose of the mower in creating a striping mow pattern. At 1228, the method 1200 may access the explore map and related mow parameters for the boundary map defined region. At 1230, the method 1200 combines the boundary and explore map as well as the mow parameters for each map to produce a comprehensive map of the region to be mowed. The comprehensive map defines the boundaries of the region as well as the obstacles within the region such that an area that can be mowed is defined.

At 1232, the method 1200 queries whether a clean-up pass is to be included in the mow pattern. A clean up pass generally causes the mower to make one or more mowing passes around the boundary of the region to perfect the overlap of the interior mowing and the boundary mowing. The clean-up pass(es) also smooth the boundary area where the mower has made turns while mowing the interior of the region. If the query is affirmatively answered, at 1234, the clean-up process may define, e.g., mow parameters, number of passes, whether each pass is offset from the previous pass and by how much of an offset, whether the clean-up is performed before the interior cutting, after the interior cutting or both, etc.

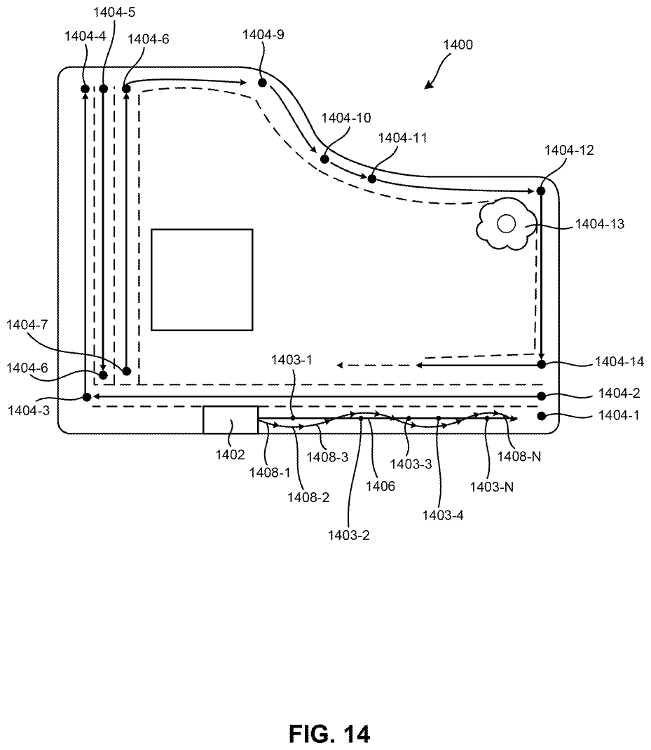

After defining the clean-up process or if the query at 1232 is negatively answered, the method 1200 proceeds to 1236 where a mow pattern may be created based on the comprehensive map. The mow pattern is established as a series of waypoints that the mower travels between as it mows. The distance between waypoints defines a stripe such that the mower mows from waypoint to waypoint and makes a turn (U or K-turn) for waypoint(s) in between stripes. Details of the method of mowing is described below with respect to FIGS. 13 and 14.

The mow pattern development further may consider the size of objects that require avoidance, e.g., a tree may be circumnavigated, but a pool may require striping on opposing sides. Also, a mowing region may require sub-dividing into sub-polygons due to a sidewalk that should not be driven over while striping. The mow pattern may consider the direction of the grass clipping exhaust from the mower deck of a side exhausting mower such that the grass clippings of the boundary mowing are exhausted inwards toward the interior of the mowing region, ensure the clippings are not exhausted onto a sidewalk or a flower bed, ensure the clippings are not exhausted toward a building to avoid a rock damaging a window or siding, and/or the like. The mow pattern may also take into account hills and berms to optimize energy use and avoid hazardous mow paths that might result in the mower tipping.

The mow pattern may also be defined to consider a fleet of mowers (i.e., a plurality of mowers) mowing adjacent regions or the same region. With a fleet mowing adjacent regions of a property, the mow pattern defines which mower in the fleet handles mowing the portion between regions (boundary overlap between regions). If the fleet of mowers is to mow the same region, the starting locations, mow parameters and waypoints for each mower may be choreographed to interleave the mowing stripes. In one example, a boundary map and an explore map may be generated using a single mower and the mow pattern generated for a fleet of mowers to mow the region.

In addition to the mow pattern comprising the way points, at 1238, the method 1200 also creates mow parameters that are associated with the mow pattern. For example, the mow parameters may comprise the type of turn to perform at each waypoint, the mower speed between waypoints, the blade speed, the blade height, and/or the like. These parameters are associated with each waypoint as metadata for the waypoint.

At 1240, The method 1200 optimizes the mow pattern and its parameters on a macro-level to minimize power consumption, improve mow coverage, improve the mow striping aesthetics, to compensate the mowing in view of past, current or future weather, to consider the current season (i.e., fallen leaves may be mowed), and/or the like.

At 1241, the method 1200 stores the mow pattern and its associated mow parameters as a mow task and ends at 1214.

If at 1224 the mow pattern is to be updated in view of additional sensor data or operator input, flow proceeds to 1242 where the previously gathered sensor data may be accessed (or otherwise received). At 1244, the previously used mow pattern and its associated mow parameters may be accessed. Using the sensor data collected during mowing or while mowing, at 1246, the mow pattern and/or parameters may be updated. This update may include changes to the mow parameters used between waypoints, removal of waypoints, the addition of waypoints to alter the mow pattern or to define a previously unknown obstacle that is to be avoided, and/or any other modification of desired mower states or parameters to mow a given area. At 1248, the method 1200 stores the updated mow pattern and/or mow parameters as an updated mow task and ends at 1214.

FIG. 13 depicts a flow diagram of a method 1300 of controlling the mower as it traverses between waypoints of the mow pattern. The method 1300 may be invoked when the controller 202 executes the mow pattern following program 332 as part of the mow control program 316 of FIG. 3. Method 1300 begins at 1302 and proceeds to 1304 where the pose of the mower is determined. At 1306, the method 1300 may set the speed of the mower based on the mower parameters within the mow task. At 1308, a waypoint is accessed, or otherwise determined. Generally, the waypoint is either the first waypoint on a waypoint list or a subsequent waypoint. In at least some examples, a waypoint of a plurality of waypoints may indicate one or more desired parameters of a mower state including, but not limited to, a position, an orientation, a velocity, a blade speed, a blade height, or the like. Alternatively, a waypoint may be, for example, defined as a delta or change in state from the prior waypoint or the starting point (e.g., the initial pose). A mowing stripe waypoint is associated with metadata to ensure the mower adheres to the mowing path. A traversal waypoint may be located at points where the mower is to turn and avoid a boundary or an obstacle. The turn may be, for example, defined as a 180 degree turn to begin a new stripe as occurs generally at the boundary, may be a partial turn to avoid an obstacle, or may be a series of turns to avoid or circumnavigate an obstacle or perform a K-turn.

At 1310, the mower motors may be energized and the mower moves a predefined increment in accordance with a subsequent waypoint. For a mowing stripe waypoint, the increment may be, for example, a 10 cm segment. As the mower moves, at 1312, a movement vector may be determined. The vector defines a direction the mower is moving. At 1314, a state of the mower may be compared to a path between waypoints (or from the start point to the first waypoint). In one example, the method 1300 uses a cost function to monitor the difference between the current mower state and the desired mower state and minimizes the cost to maintain the mower on the striping path. The cost function may be weighted such that, the function is very tightly controlled along the striping path (between striping waypoints) but may be loosely controlled at the traversal waypoints while making a turn. Based on the cost function, at 1316, the method 1300 may adjust drive parameters (e.g., applies left or right braking) to direct the mower towards the path. If the vector and path are aligned at 1314 or the adjustment is complete, the method 1300 proceeds to 1318. The process for maintaining drive alignment is further described with respect to FIG. 14.

At 1318, the method 1300 queries whether the mower should continue, e.g., the mowing process is complete or not. If the mowing is complete, the method 1300 ends at 1320. If the mowing is not complete, the method 1300 proceeds to 1322 and queries whether the mower has arrived at the next waypoint.

If the mower is at the next traversal waypoint, the method 1300 proceeds the 1324 and proceeds to make a turn. The turns may be defined in the waypoint metadata as to the type of turn, e.g., partial, full, K-, U-turn, etc. Once the turn is complete, the method 1300 proceeds to 1304 to begin the process again to select the next waypoint and drive there.

If at 1322, the mower is at a striping waypoint, the method 1300 proceeds to 1310 to make the next incremental move along the path. The increments run one after another such that the motion of the mower is continuous.

FIG. 14 depicts an aerial, schematic view of a property 1400 to be mowed using the mow method 1300 of FIG. 13 in accordance with an example of the invention. An initial location is indicated at 1402 and consecutive waypoints are indicated as 1403-N (striping waypoints) and 1404-N (traversal waypoints) (N being an integer). Using the method 1300 of FIG. 13, the mower may move along path 1406 using incremental motion vectors 1408-1, 1408-2, . . . , 1408-N. In one example, a proportional integral algorithm (cost function) attempts to maintain a zero difference between each incremental vector 1408 and the path 1406 between striping waypoints 1403-N. In additional or alternative examples, an optimization may be performed to minimize a difference between a current state of the lawn mower and a state defined by a waypoint and/or interpolated between two waypoints on either side of the lawn mower. At the traversal waypoints 1404-N, a turn is made that places the mower at the next adjacent waypoint, e.g., 1404-1 to 1404-2. Then, the mower may move along the path 1406 between waypoints 1404-2 and 1404-3 using striping waypoints (not shown for clarity). At traversal waypoint 1404-3, the mower turns 90 degrees to move toward traversal waypoint 1404-4. At traversal waypoint 1404-12, the mower may circumnavigate the tree as a single turn, then proceed from traversal waypoint 1404-13, after the turn, to traversal waypoint 1404-14. The circumnavigation may be performed by a single radius turn established by the waypoint metadata or through a series of waypoints around the tree that inform the mower of a proper path to avoid the tree. Alternatively, the mower may not have a preplanned path around the tree and be enabled to use its sensors to circumnavigate the tree (or other obstacle). The process continues from waypoint to waypoint until the entire lawn is mowed while avoiding the obstacles and staying within the boundary. Multiple striping waypoints may be used along a single segment of path 1406 to minimize an amount of drift or otherwise. A number of striping waypoints may be determined based at least in part on a drift associated with a planning component of the lawn mower, an amount of computational resources required to evaluate the waypoints, or the like.

Once the lawn is mowed, the mow pattern may contain a clean-up pattern (additional waypoints, not shown) that may cause the mower to re-mow the boundary to clean up turns and extra grass clippings that require mulching. Multiple passes around the boundary may occur using the mower offset slightly (e.g., half mower or less) on each new pass.

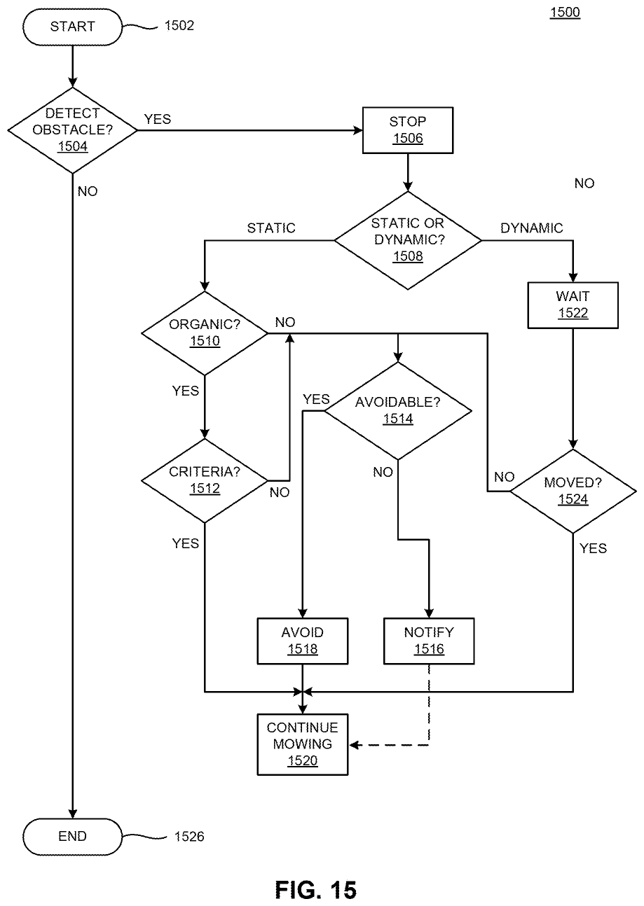

If, at any time during execution of the mow method 1300 of FIG. 13, the sensors detect an unknown obstacle (i.e., not accounted for in the mow pattern) that may impede the progress of the mower, the mower controller executes an interrupt (for example, obstacle handling program 334 of FIG. 3) that handles the obstacle. The object that forms the obstacle may be in the current path of the mower or may be proximate the mower such that the object may form an obstacle during a future stripe being mowed. FIG. 15 depicts a flow diagram of an obstacle handling method 1500 in accordance with at least one example of the invention. The interrupt method 1500 may determine the existence of an object that may form an obstacle, then determines whether the obstacle is static (not moving) or dynamic (moving). In either case, the mower will stop before hitting or mowing over the obstacle. If the obstacle is static, the method determines if the obstacle is organic (e.g., a stick) and, if it is, applies mowing criteria to the situation to determine if the object is either avoidable or can be mowed over. If not avoidable or mowable, the mower does not move and notifies an operator of the situation. The forgoing decisions (i.e., static, dynamic, organic) may be made through semantic matching of known object types to the sensor data being collected regarding the current object. For example, the current imagery from the cameras of a tree branch is compared to semantics defining a tree branch to enable the mower to determine that the obstacle is static and organic (i.e., the imagery “looks” like a tree branch.

If the obstacle is dynamic (e.g., a person walking in front of the mower), the mower waits to see if the obstacle moves and clears the path in front of the mower. The mower may also sound an alarm (e.g., toot a horn, flash light(s), etc.) to alert the obstacle or, assuming the obstacle is an animal, scare the obstacle into moving from the path. If so, the mower continues. If not, the mower notifies an operator of the situation.

In many instances, the operating company policies will define how a mower handles an obstacle, i.e., whether the obstacle is mowed or not. Some policies may have the mower stop at all obstacles, other policies may direct the mower to mow over all branches under a certain size. When an operator is notified, the operator may update the obstacle handling policy for subsequent obstacle encounters.

More specifically, the method 1500 begins at 1502 and proceeds to 1504 where the method 1500 determines whether an obstacle exists in the path of the mower. If there is no obstacle the method ends at 1526—the mower continues to mow without interruption. However, if, at 1504, an obstacle is detected, the mower stops at 1506.

At 1508, the method 1500 may analyze the sensor data to determine if the obstacle is static or dynamic, i.e., stationary or not stationary. For example, if the obstacle is stationary for a predefined period of time, the obstacle is deemed static and the method 1500 proceeds to 1510. Alternatively, the sensor data may contain motion sensing data (sonic, radar, lidar, or visible images) that may be analyzed upon request or continuously to determine whether the obstacle is static or dynamic. At 1510, the method 1500 may analyze the sensor data to determine if the obstacle is organic or not. An organic obstacle may be a small branch, leaf pile or other object that can be mowed over, i.e., “mowable.” Again, such an analysis may be applied to the sensor imagery upon request or continuously. The obstacle may be classified using the semantics of the obstacle to determine the type of obstacle, i.e., stick, litter, branch, rock, toy, etc. In one example, the classification may be performed using a neural network or other form of artificial intelligence. At 1512, the sensor data is matched to mowable criteria such as size and type of object as well as the operating company's obstacle handling policy. For example, the cameras may be used to image the object and the analysis may determine the size and type of object, e.g., small branch (mowable) versus large branch (not mowable). In another example, the analysis may show the object is a paper cup—although a paper cup is mowable, the criteria for mowability may be set to not mow paper cups, which would result in shreds of paper on the lawn. If the object is deemed mowable, the method 1500 proceeds to 1520 and continues to mow in accordance with the mow pattern.

If, at 1510, the object is deemed inorganic, or, at 1512, the object does not meet the mowable criteria, the method 1500 may proceed to 1514 where the method 1500 may analyze the sensor data and determine whether the obstacle is avoidable. If the obstacle is avoidable, such as a child's toy, tool, lawn furniture, etc., the method 1500 plots a course to circumnavigate the obstacle. In some instances, the method 1500 may have detected the obstacle prior to approaching the obstacle such that the analysis is performed without stopping at 1506.

At 1518, the mower determines a path to avoid the obstacle. The path may be logged to be considered for use to update the mow pattern. At 1520, the method 1500 may continue mowing in accordance with the mow pattern.

If the obstacle is deemed not to be avoidable or the method 1500 cannot determine an avoidance path or the obstacle is of an unknown type, the method may proceed to 1516 and notify an operator that an obstacle has caused the mower to stop. The operator may manually route the mower around the obstacle either through local control or remote control. Alternatively, the operator may move the obstacle from the path of the mower. Once the mower is manually repositioned or the obstacle removed, the mow pattern may be continued at 1520.

If, at 1508, the obstacle is deemed to be dynamic, the mower may wait at 1522 for a predefined period or until the obstacle has moved from the path of the mower. At 1524, the method 1500 queries whether the obstacle has moved and, if the obstacle has moved, the mowing may continue at 1520. If the obstacle has not moved, the mower remains stopped and, at 1514, the method may attempt to avoid the obstacle as described above. If avoidance is not possible or the method 1500 cannot determine an avoidance path or the obstacle is of an unknown type, at 1516, an operator may notified of the obstacle. The operator may manually drive the mower around the obstacle or remove the obstacle such that, at 1520, the mower may continue mowing the mow pattern. The method 1500 ends at 1526.

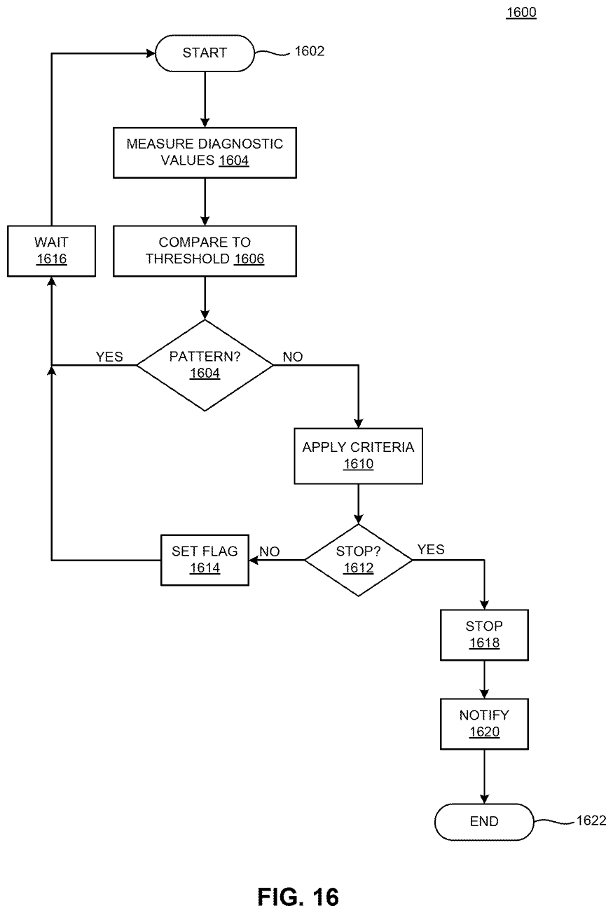

FIG. 16 depicts a flow diagram of a mower diagnostic monitoring method 1600 in accordance with an example of the invention. The mower diagnostic monitoring method 1600 may be invoked when controller 202 executed the mower diagnostics program 336 of FIG. 3, and/or on each mow, intermittently throughout a mowing task, or continuously. The method 1600 begins at 1602 and proceeds to 1604 where the method 1600 may measure mower diagnostic values such as, but not limited to, battery charge, battery temperature, motor torque, motor temperature, mowing path tracking error, etc. At 1606, the measured values may be compared to a threshold that indicates whether the values are within norms for the particular value. At 1608, the method 1600 may query whether the values meet the threshold criteria. If the query is affirmatively answered (i.e., values are within norms), the method 1600 may proceed to 1616 where the method may wait such that the value measuring at 1604 is performed periodically. In other examples, the measurements may be continuous. Also, different diagnostic values may be measured at different periodicity. If the query is negatively answered, the method 1600 proceeds to 1610.

At 1610, diagnostic criteria may be applied to the errant or anomalous diagnostic value. The criteria is used to determine if the value is critical and must result in the mower stopping or is the value not critical such that the mower may continue operating. For example, the battery temperature being above the battery's operating temperature may be deemed a critical anomaly that requires immediate attention. At 1612, the method 1600 ay query whether the criteria have been met to warrant the mower stopping. If the query is negatively answered (i.e., no stop), the method 1600 may proceed to 1614 where the method 1600 may set a flag regarding the value such that an operator may investigate the issue after mowing is complete. The method 1600 then may proceed to 1616 and continue monitoring the diagnostic values.

If the query at 1612 is affirmatively answered, the method 1600 may proceed to 1618 where the mower is stopped and, at 1620, an operator may be notified of the stoppage via warning indicator, text message, email, etc. The method 1600 ends at 1622.

### Example Clauses

A. A system comprising: TBD

### CONCLUSION

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e. within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g., A, AB, AB, ABC, ABB, etc.). When “and/or” is used, it should be understood that the elements may be joined in the alternative or conjunctive.

1. An autonomous lawn mower comprising:
a sensor;
one or more processors; and
one or more non-transitory computer readable media having instructions stored thereon, which, when executed by the one or more processors, cause the one or more processors to perform operations comprising:
receiving boundary information associated with a boundary of a region to be mowed;
receiving sensor data from the sensor while traversing at least a portion of the region within the boundary;
if one or more objects exist within the region, determining, based at least in part on the sensor data, one or more objects in the region;
receiving a mow pattern, where the mow pattern is based at least in part on the boundary information and the one or more objects; and
controlling the lawn mower to mow the region based on the mow pattern.

2. The autonomous lawn mower of claim 1, wherein the boundary information comprises one or more of:
an initial position for the autonomous lawn mower within the region, or boundary locations defining a perimeter of the region.

3. The autonomous lawn mower of claim 1, wherein traversing the at least the portion of the interior region comprises controlling the autonomous lawn mower to move in accordance with a random walk algorithm or a striping algorithm.

4. The autonomous lawn mower of claim 1, wherein the operations further comprise determining one or more mow parameters associated with the mow pattern, and
wherein the one or more mow parameters comprise at least one or more of a mower speed, a blade deck height, deck type or a blade speed.

5. The autonomous lawn mower of claim 1, wherein the mow pattern comprises a series of waypoints and mowing occurs by traveling along a path from one waypoint to a next waypoint.

6. The mower of claim 5, wherein the controlling comprises using incremental motion vectors compared to the path and reducing an error between each incremental motion vector and the path.

7. The autonomous lawn mower of claim 1, wherein the operations further comprise:
detecting an obstacle in a path of the lawn mower;
determining whether the obstacle is static or dynamic; and
performing one or more of:
controlling the lawn mower based at least in part on determining whether the obstacle is static or dynamic, or
transmitting a signal, the signal configured to provide notification of the obstacle.

8. The lawn mower of claim 1 wherein the controlling the lawn mower to mow the region comprises receiving additional sensor data from the sensor while mowing the region and using the additional sensor data to update a mow pattern or a mow parameter.

9. A method comprising:
receiving boundary information defining a boundary of a region to be mowed;
controlling a lawn mower to traverse at least a portion of the region;
receiving sensor data from a sensor associated with the lawn mower;
if one or more objects exist within the region, determining, based at least in part on the sensor data, one or more objects in the region;
receiving a mow pattern, where the mow pattern is based at least in part on the boundary information and the one or more objects; and
controlling the lawn mower to mow the region based on the mow pattern.

10. The method of claim 9, further comprising determining, based at least in part on the sensor data, one or more objects in the region,
wherein determining one or more objects in the region comprises controlling the lawn mower in accordance with a random walk algorithm or a striping algorithm.

11. The method of claim 9, further comprising determining a mow parameter associated with the mow pattern, wherein the mow parameter comprises at least one or more of a mower speed, a blade deck height, deck type or a blade speed.

12. The method of claim 9, wherein the mow pattern comprises a series of waypoints, and wherein controlling the lawn mower to mow the region based on the mow pattern comprises controlling the lawn mower to minimize a difference between a state of the lawn mower and a state defined by one or more waypoints of the series of waypoints.

13. The method of claim 9, wherein controlling the mower to mow the region further comprises:
detecting an obstacle proximate the lawn mower;
determining whether the obstacle is static or dynamic; and
performing one or more of:
controlling the lawn mower based at least in part on determining whether the obstacle is static or dynamic, or
transmitting a signal, the signal configured to provide notification of the obstacle.

14. The lawn mower of claim 9 wherein the controlling the lawn mower to mow the region comprises receiving additional sensor data from the sensor while mowing the region and using the additional sensor data to update a mow pattern or a mow parameter.

15. One or more non-transitory computer readable media having instructions stored thereon, which, when executed by one or more processors, cause the one or more processors to perform operations comprising:
receiving boundary information defining a boundary of a region to be mowed;
controlling a lawn mower to traverse at least a portion of the region;
receiving sensor data from a sensor associated with the lawn mower;
receiving a mow pattern, where the mow pattern is based at least in part on the boundary information and the sensor data; and
controlling the lawn mower to mow the region based on the mow pattern.

16. The one or more non-transitory computer readable media of claim 15, wherein the operations further comprise detecting, based at least in part on the sensor data, one or more objects in the region,
wherein the mow pattern is further based at least in part on the one or more objects, and
wherein controlling the lawn mower to traverse the at least the portion of the region comprises controlling the lawn mower in accordance with a random walk algorithm or a striping algorithm.

17. The one or more non-transitory computer readable media of claim 15, wherein the operations further comprise determining a mow parameter associated with the mow pattern, and
wherein the mow parameter comprises at least one or more of a mower speed, a blade deck height, deck type or a blade speed.

18. The non-transitory computer readable media of claim 15, wherein the mow pattern comprises a series of waypoints, and
wherein controlling the lawn mower to mow the region comprises controlling the lawn mower to minimize a difference between a state of the lawn mower and a state defined by one or more waypoints of the series of waypoints.

19. The one or more non-transitory computer readable media of claim 15, wherein the operations further comprise:
detecting an obstacle proximate the lawn mower that impedes progress of the lawn mower;
determining whether the obstacle is static or dynamic; and
performing one or more of:
controlling the lawn mower based at least in part on determining whether the obstacle is static or dynamic, or
transmitting a signal, the signal configured to provide notification of the obstacle.

20. The one or more non-transitory computer readable media of claim 15, wherein controlling the lawn mower to mow the region comprises receiving additional sensor data from the sensor while mowing the region and using the additional sensor data to update a mow pattern or a mow parameter.
